(19) United States
(12) Patent Application Publication
(10) Pub. No.: US 2026/0062221 A1
(43) Pub. Date: Mar. 5, 2026

(54) CONVEYOR UNDERGUARD

(71) Applicant: Dematic Corp., Grand Rapids, MI (US)

(72) Inventors: Daniel R. Van Laar, Hudsonville, MI (US); Travis Smith, Comstock Park, MI (US); Daniel Schmitt, Grand Rapids, MI (US); Jeffrey Morris, Zeeland, MI (US)

(21) Appl. No.: 19/316,214

(22) Filed: Sep. 2, 2025

Related U.S. Application Data
(60) Provisional application No. 63/689,182, filed on Aug. 30, 2024.

(51) Int. Cl. B65G 13/11

(52) U.S. Cl. CPC B65G 13/11

(57) ABSTRACT

A conveyor guard adapted for use with a conveyor having a pair of spaced apart side channels, each having a lower flange and a plurality of openings on each flange, with the conveyor guard comprising a panel having a non-metallic top wall, a non-metallic bottom wall, at least one inner wall disposed between the top and bottom walls and a pair of lateral edges, where the top, bottom and middle walls allow light to pass through so as to be transparent or translucent. The conveyor guard panel is sized such that the lateral edges align with respective ones of the lower flanges of the pair of spaced apart side channels of the conveyor when mounted thereto.

### CROSS REFERENCE TO RELATED APPLICATION

The present application claims the priority benefit of U.S. provisional patent application Ser. No. 63/689,182, filed on Aug. 30, 2024, which is incorporated herein by reference in its entirety.

### BACKGROUND AND FIELD OF THE INVENTION

The present disclosure is directed to a conveyor system, and in particular guards used for conveyor systems.

Conveyors used in industrial applications may have multiple rotating rollers that are either powered for rotation or have bearings that permit rotation to permit displacement of products from one location to a second location. Multiple electrical system components used to monitor and/or power the conveyors are provided in front of or under the conveyor. Guards for use with such conveyors are known, such as for use in mitigating against an operator or repair person reaching into the mechanisms and/or electrical components of the conveyor.

### SUMMARY OF THE INVENTION

The present invention provides a non-metallic conveyor guard panel configured for attachment to the underside of a conveyor assembly to both mitigate against an operator or repair person reaching into the mechanisms and/or electrical components of the conveyor, as well as enable such a person to observe aspects of the conveyer assembly from beneath the conveyor assembly through the conveyor guard panel.

According to an aspect of the present invention, a conveyor guard that is adapted for use with a conveyor having a pair of spaced apart side channels, with the side channels each having a lower flange and a plurality of openings on each flange comprises a conveyor guard panel having a non-metallic top wall, a non-metallic bottom wall, and at least one inner wall disposed between the top and bottom walls, and a pair of lateral edges, where the top, bottom and middle walls allow light to pass there through such that the conveyor guard panel is transparent or translucent. The conveyor guard panel is sized such that the lateral edges align with respective ones of the lower flanges of the pair of spaced apart side channels of the conveyor when mounted thereto.

In particular embodiments the at least one inner wall extends between each of the lateral edges. The inner wall may comprise a plurality of transverse walls such as a plurality of transverse walls that are disposed perpendicularly to the top and bottom walls. Still further, the at least one inner wall may further comprise a plurality of middle walls, where the middle walls are disposed parallel to the top and bottom walls, such as for example with each middle wall being disposed between a pair of transverse walls. In particular embodiments the top wall, bottom wall and at least one inner wall are unitarily formed.

In still a further particular embodiment the at least one inner wall comprises a wave shaped wall, where opposite ends of the wall are disposed at the lateral edges with each opposite end defining a sinusoidal or triangular shape. The wave shaped wall may be joined with each of the top and bottom walls. Still further, the at least one inner wall may further comprise a middle wall and another wave shaped wall, where the middle wall extends parallel to both the top and bottom walls and where one wave shaped wall is disposed between the top and middle walls and the other wave shaped wall is disposed between the middle wall and the bottom wall.

In yet another particular embodiment the at least one inner wall comprises a plurality of transverse walls forming hexagonal walls.

In any of the embodiments the conveyor guard may include mounting holes adjacent each of the lateral edges with at least some of the mounting holes at each lateral side aligning with at least one opening on each flange of the conveyor. A plurality of connectors may be used for mounting the conveyor guard to the conveyor.

In a particular embodiment the connectors each comprise a threaded fastener having a head, a nut and a spacer with the conveyor guard panel being disposed between the nut and head at the spacer. The connectors may further comprise one or more washers between the head and nut, and a retaining ring may be disposed over the threaded fastener adjacent to one of the washers to retain the connector to the conveyor guard prior to installation of the conveyor guard to the conveyor.

In a still further embodiment, the connectors may comprise a retainer nut and a retainer pin, with the retainer pin being insertable into the retainer nut with the conveyor guard panel disposed therebetween. In particular embodiments the retainer pin comprises a post with a projection and the projection engages with the retainer nut for securing the retainer nut and retainer pin together. In still another embodiment, the conveyor guard panel further includes a magnetic sleeve disposed at selected ones of the mounting holes with at least one of the retainer pin and the retainer nut being metallic.

In any of the embodiments the top, bottom and/or at least one inner wall may be polymeric and/or may be plastic. For example, the top, bottom and/or at least one inner wall may be at least one of polycarbonate plastic, polyvinyl chloride (PVC), acrylic sheets or fiberglass.

A conveyor system in accordance with aspects of the present invention comprises a pair of spaced apart side channels, each having a lower flange and a plurality of openings on each flange, a plurality of conveyor rollers extending between the side channels, and at least one conveyor guard panel mounted beneath the side channels at the lower flanges, where the conveyor guard panel may be constructed as discussed above.

In a particular embodiment the at least one conveyor guard comprises a plurality of conveyor guard panels, where each conveyor guard comprises transverse edges and where the conveyor guards are mounted to the side channels with a transverse edge of each conveyor guard adjacent to a transverse edge of another conveyor guard.

The conveyor guard and conveyor system in accordance with the present invention provides a light weight and cost effective guard for improved safety and installation and which includes an underguard panel that is transparent or translucent to enable personnel to observe objects and conveyor features through the underguard panel and that may be readily configured and/or reworked, such as by sawing and/or drilling, to work around obstacles on or adjacent to the conveyor system. These and other objects, advantages, purposes and features of this invention will become apparent upon review of the following specification in conjunction with the drawings.

### BRIEF DESCRIPTION OF THE DRAWINGS

FIG. 1A is a partial side perspective view of a conveyor system in accordance with aspects of the present disclosure having a conveyor underguard assembly;

FIG. 1B is a side elevation view of the conveyor system of FIG. 1A;

FIG. 1C is a partial longitudinal bottom perspective view of the conveyor system of FIG. 1A;

FIG. 1D is a partial transverse bottom perspective view of the conveyor system of FIG. 1A;

FIG. 2 is a bottom perspective view of an underguard panel of the underguard assembly of FIG. 1A shown removed from the conveyor system;

FIG. 3 is a bottom plan view of the underguard panel of FIG. 2;

FIG. 4 is a side view of the underguard panel of FIG. 2;

FIG. 5 is a close up partial perspective view of an edge of the underguard panel of FIG. 2;

FIG. 6 is a close-up partial perspective view of a portion of the conveyor system of FIG. 1A illustrating the attachment of an underguard panel to the conveyor by a connector;

FIGS. 7 and 8 disclose an embodiment of a connector for attaching an underguard panel to a conveyor in accordance with the present disclosure;

FIG. 9 is a top perspective view of the underguard panel of FIG. 2 shown with connectors of FIGS. 7 and 8;

FIG. 10 is a partial side view of the underguard panel and connector assembly of FIG. 9;

FIG. 11 is a top plan view of an alternative underguard panel in accordance with aspects of the present disclosure;

FIGS. 12-17 are partial side perspective views of alternative underguard panels in accordance with still further aspects of the present disclosure;

FIG. 18 is an exploded assembly view of an alternative embodiment of a connector for attaching an underguard panel to a conveyor in accordance with the present disclosure;

FIG. 19 is a side assembly view of the connector of FIG. 18 shown in relation to an underguard panel and conveyor portion; and

FIG. 20 is a side assembly view of still another connector embodiment in relation to an underguard panel and conveyor portion.

### DESCRIPTION OF THE PREFERRED EMBODIMENTS

The present invention will now be described with reference to the accompanying figures, wherein the numbered elements in the following written description correspond to like-numbered elements in the figures.

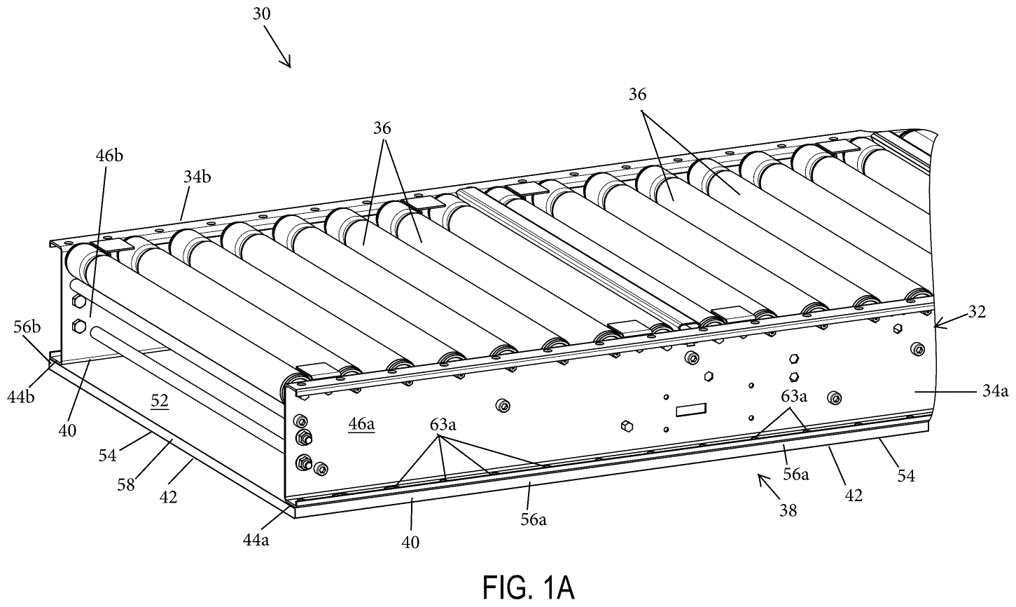

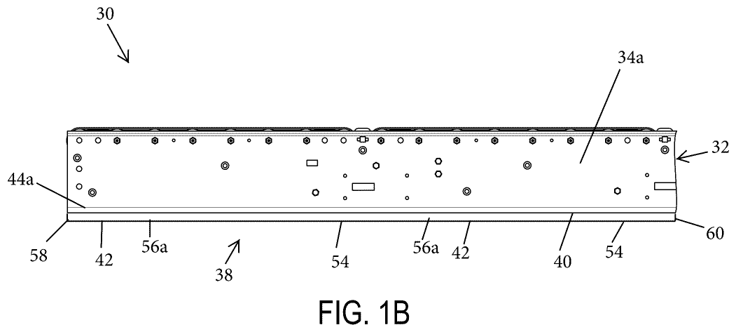

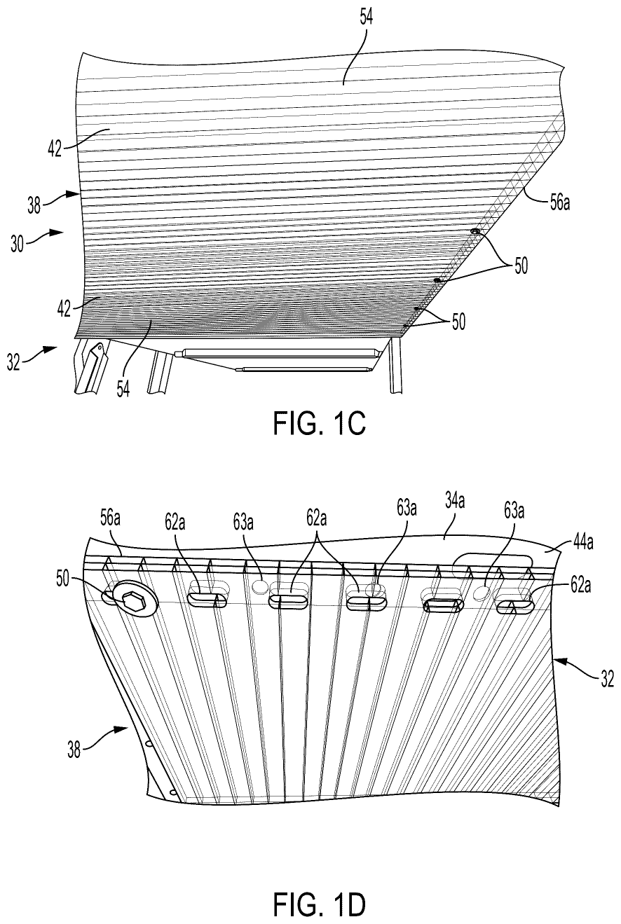

FIGS. 1A-1D illustrate a portion of a conveyor system 30 in accordance with aspects of the present invention. Conveyor system 30 includes a conveyor assembly 32 comprising a pair of side frames 34a, 34b between which are mounted conveyor rollers 36 that define a conveying surface upon which goods may be transported. Although not shown in the illustrated embodiment, conveyor assembly 32 may additionally include numerous additional components disposed between side frames 34a, 34b, such as electrical and/or pneumatic components as well as mechanical components, such as hanger bars and the like. Conveyor system 30 thus further includes an underguard assembly 38 mounted to a bottom portion 40 of conveyor assembly 32, where underguard assembly 38 inhibits personnel from reaching upwards from the bottom portion 40 of conveyor assembly 32 as may otherwise be attempted during operation of conveyor assembly 32, as well as may catch debris or other objects that may fall between gaps in the rollers 36, and prevents unauthorized personnel from tampering with the conveyor assembly 32. In the illustrated embodiment, and as discussed in more detail below, underguard assembly 38 comprises underguard panels 42 constructed from a non-metallic transparent corrugated polymeric material, which in the illustrated embodiment comprises a plastic material.

As understood from FIGS. 1A-1D, underguard panels 42 are configured to have a width transverse to the conveying direction that extends over the bottom portion 40 of the conveyor assembly 32 sufficient to enable mounting of the underguard panels 42 to the conveyor assembly 32, such as to the bottom portion 40. For example, as understood from FIG. 1A, underguard panels 42 extend and mount between respective bottom flanges 44a, 44b of side frames 34a, 34b, where each side frame 34a, 34b has a generally C-shaped outwardly oriented cross-sectional profile with the bottom flanges 44a, 44b extending outwardly from the respective sidewalls 46a, 46b of the side frames 34a, 34b. Connectors 50, that are described in more detail below, are used to attach underguard panels 42 to the bottom flanges 44a, 44b.

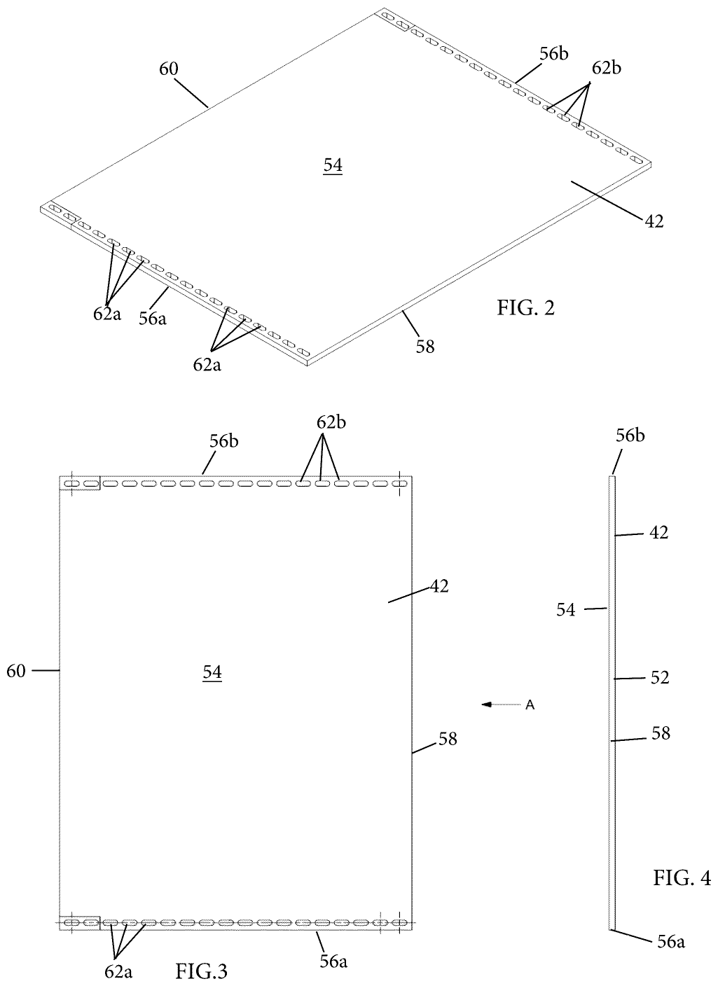

Referring now to FIGS. 2-5, each underguard panel 42 is rectangular and has a top side 52, a bottom side 54, lateral edges 56a, 56b and transverse edges 58, 60. A series of slotted mounting holes 62a, 62b are provided along each lateral edge 56a, 56b, where mounting holes 62a, 62b are through holes used with connectors 50 for mounting to the bottom flanges 44a, 44b of the side frames 34a, 34b. Bottom flanges 44a, 44b correspondingly include apertures 63a (not shown on flange 44b) for receiving connectors 50, as discussed below. When underguard panels 42 are mounted to conveyor assembly 32, lateral edge 56a is disposed at side frame 34a, lateral edge 56b is disposed at side frame 34b, and transverse edges 58, 60 extend between side frames 34a, 34b.

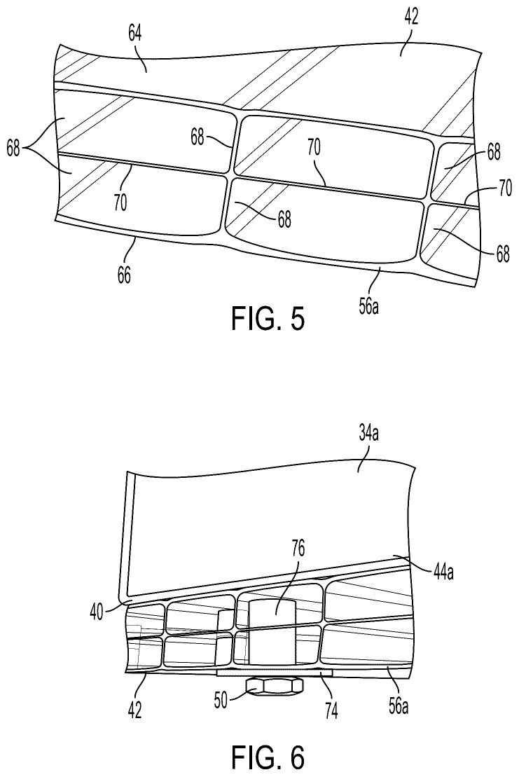

As noted, underguard panels 42 comprise a transparent corrugated plastic material. One particular embodiment of such a corrugated core configuration within the scope of the present disclosure is shown in FIG. 5, which illustrates a close-up view of a lateral edge 56a of an underguard panel 42. As shown in FIG. 5, the corrugated core configuration comprises a top wall 64, a bottom wall 66 and inner walls comprising multiple transverse walls 68 with a middle wall 70 disposed between the top and bottom walls 64, 66 and intersecting the transverse walls 68. The middle wall 70 may extend from one transverse edge 58 to the other transverse edge 60, and the middle wall 70 and each transverse wall 68 may extend from one lateral edge 56a to the other lateral edge 56b. The transverse walls 68 may be considered to have two separate portions relative to the middle wall 70. Moreover, although referenced herein as if the middle wall 70 were continuous it should be further appreciated that the middle wall 70 may be considered to comprise a plurality of middle walls extending between transverse walls. The top wall 64 defines the top side 52 and the bottom wall defines the bottom side 54. It should be appreciated that the underguard panel 42 may be made from an extrusion process by which the top, bottom, transverse and middle walls are all simultaneously formed and thus comprise a unitary construction. When underguard panels 42 are mounted to conveyor assembly 32, the transverse walls 68 extend transversely relative to the conveying direction of conveyor assembly 32, that is, between lateral edges 56a, 56b. In the illustrated embodiment, panels 42 are constructed whereby transverse walls 68 extend parallel to rollers 36. It should be appreciated, however, that alternatively oriented inner walls or transverse walls may be employed. Moreover, alternatively shaped underguard panels may also be utilized, including panels that have a longer length than width or vice versa, or are curved, or the like.

Mounting holes 62a, 62b extend through top, bottom and middle walls 64, 66, 70 and may also intersect one or more transverse walls 68. With reference to FIG. 6, connectors 50 extend through selected ones of the mounting holes 62a, 63b for attaching underguard panel 42 to the bottom portion 40 of the conveyor assembly 32 at the underside of a bottom flange 44.

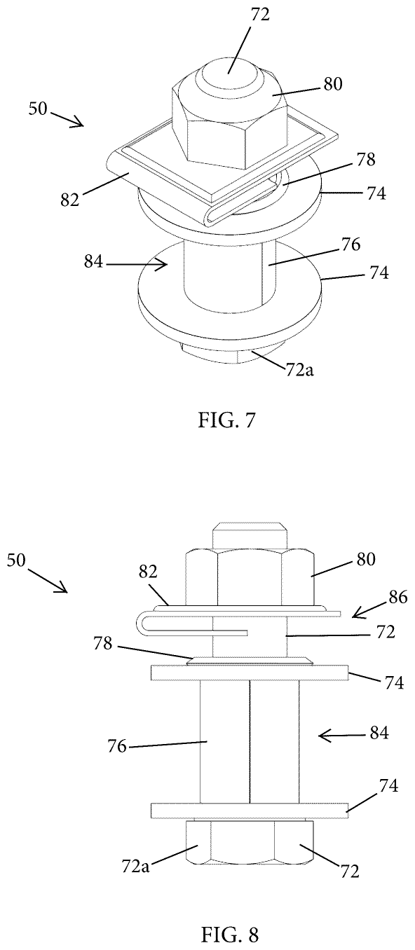

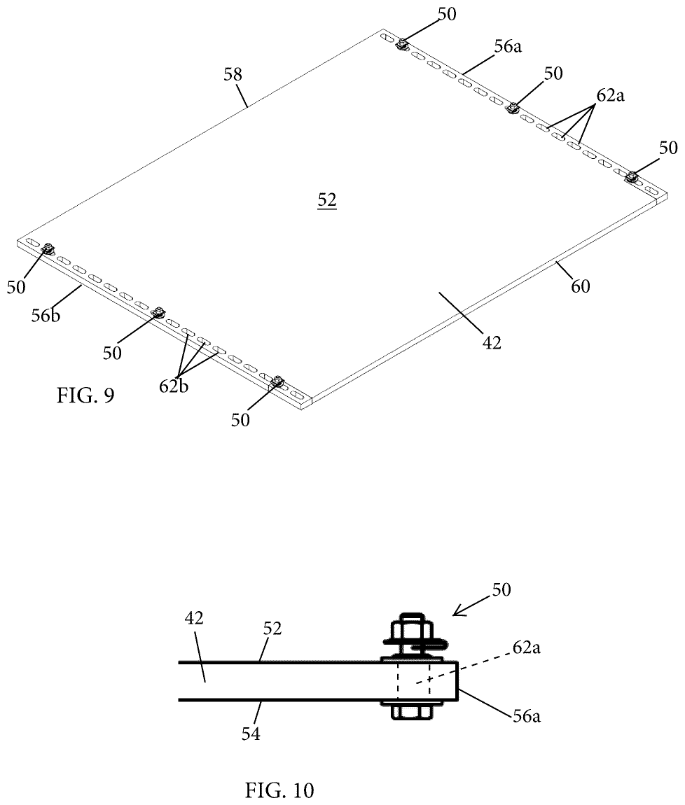

As shown in FIGS. 7 and 8, the illustrated connector 50 is an assembly that includes a hex cap threaded fastener or screw 72, a pair of washers 74 that are separated along the length of fastener 72 by a tubular spacer 76. A retaining ring 78 is provided to retain the washers 74 and spacer 76 on fastener 72. Connector 50 further includes a retainer nut 80 having an integrated flange 82 connected to the nut 80. Spacer 76 creates a gap or space 84 between washers 74 within which underguard panel 42 is disposed (FIG. 10) when mounted to conveyor assembly 32. In use, the washer 74 furthest from the hex head 72a of the fastener 72 is positioned in place after the fastener 72 has been inserted through one of the mounting holes 62a, 62b of the panel 42, with the retaining ring 78 then installed to thereby retain the fastener 72, washers 74 and spacer to the panel 42. Upon pre-installing multiple of such portions of the connectors 50 to a panel 42, to then mount the panel 42 to the conveyor assembly 32, the opposite end of the fastener 72 is inserted through an aperture 63a of one of the bottom flanges 44a, 44b of side frames 34a, 34b and fastened into the retainer nut 80 such that the width of the bottom flange 44a, 44b of side frames 34a, 34b is disposed at 86 between the retainer ring 78 and adjacent washer 74 and the flange 82 of the retainer nut 80. Spacer 76 is then compressed between washers 74 when nut 80 is threaded onto fastener 72, with the underguard panel 42 having a thickness that is intended to be similar to or slightly less than the length of spacer 76 such that the underguard panel 42 is not compressed, or slightly compressed by the tightening of nut 80 to fastener 72. That is, the spacer 76 is compressed more than the underguard panel 42 to avoid damaging or breaking the underguard panel 42.

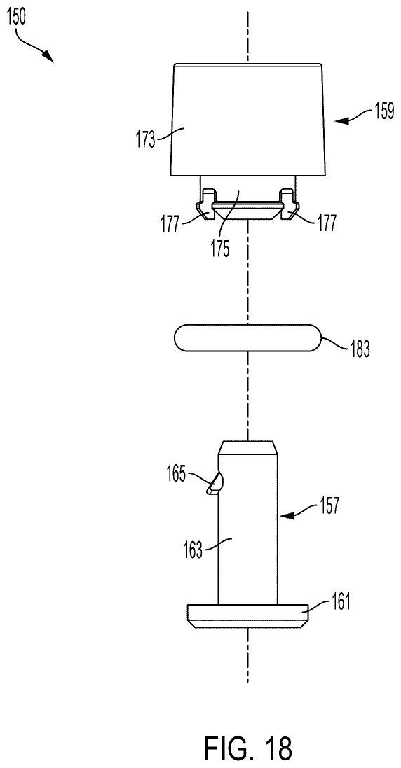

FIGS. 9 and 10 illustrate the attachment or connection of connectors 50 to a panel 42 prior to being mounted to a conveyor assembly 32. The retainer nut 80 is shown thereon for reference purposes only but is understood to be removed for positioning the screw 72 through an aperture 63a on the bottom flange 44a, 44b and replaced to secure the panel in place. As shown in FIG. 9, a panel 42 may be held in place by three connectors 50 on each lateral edge 56a, 56b. However, more or fewer connectors 50 may be used. It should further be appreciated that alternative connectors 50 may be used. This includes, for example, rivets or the alternatively embodied connectors 150, 250 illustrated in FIGS. 18-20. It should be appreciated that multiple panels 42 may then be mounted to the conveyor assembly 32 in end-to-end abutting arrangement.

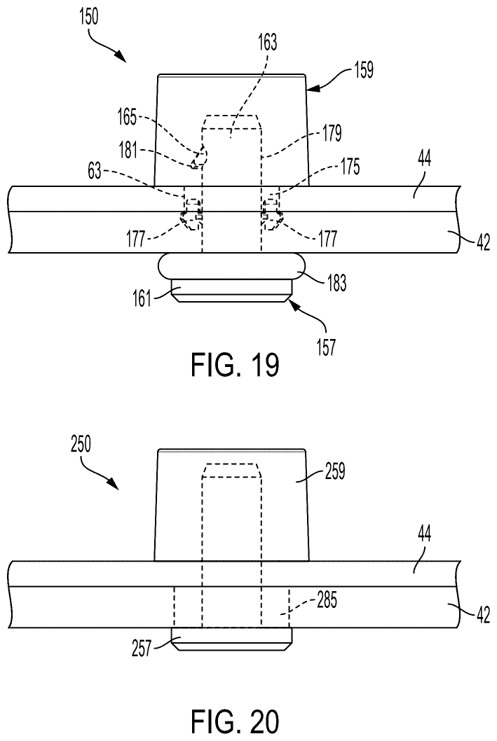

Alternatively embodied connector 150 of FIGS. 18 and 19 comprises a retainer pin 157 that connects with a retainer nut 159, where the pin 157 presses into and engages with the nut 159 with the underguard 42 secured to a bottom flange 44 of a side frame 34 of a conveyor assembly 32 therebetween. Retainer pin 157 includes a base 161 with an upward extending post 163, and with one or more projections 165 extending radially outwardly form post 163 (one shown in FIG. 18). Nut 159 in turn includes a head 173 and a foot 175, where head 173 has a larger outer perimeter than foot 175 and with foot 175 including one or more projections 177, such as three projections 177 in a particular embodiment. Nut 159 additionally includes an internal receptacle or cavity 179 for receiving post 163, with cavity 179 including a ledge 181 to which the projection 165 on post 163 engages for connecting the pin 157 and nut 159 together. In use, foot 175 of nut 159 is pressed through a selected aperture 63 in the bottom flange 44 of a side frame 34, with the projections 177 engaging therewith to clip the nut 159 into place. Subsequently, the post 163 of pin 157 is inserted upwardly through a mounting hole 62 of the underguard 42 with an o-ring 183 disposed between the bottom side 54 of the underguard 42 and the base 161 of the pin 157. The post 163 is then inserted into the cavity 179 of the nut 159 with the projection 165 on the post 163 engaging with the ledge 181 of the nut 159 whereby the pint 157 is fixedly secured to the nut 159.

Still another alternative connector 250 is illustrated in FIG. 20 which in generally similar manner to connector 150 includes a retainer pin 257 and a retainer nut 259 that engage together to mount an underguard 42 to the bottom flange 44 of a side frame 34 of a conveyor assembly 32. Connector 250 further comprises and utilizes a magnetic ring or sleeve 285 that is embedded into the mounting hole 62 of the underguard 42, with retainer pin 257 and retainer nut 259 being metallic. In a particular embodiment ring 285 comprises a correlated magnet such as with multiple poles. Connector 250 may be configured to provide a substantially strong connection of underguard 42 to bottom flange 44. For example, the strength of the connection may be such that one or more of the components of connector 250 fracture upon disassembly, thereby further preventing tampering therewith. It should be appreciated that side frame 34 in the illustrated embodiments disclosed herein is metallic. Still further, although discussed herein has having a magnetic ring 285 and metallic pin 257 and nut 259 that are attracted to a magnet, it should be appreciated that alternatively configured components/materials of a connector 250 may be arranged, such as with one or more of a pin and nut that are magnetic and/or without such a magnetic ring 285.

In the illustrated embodiment of underguard panel 42, both top and bottom walls 64, 66 comprise solid walls such that any items falling from the conveyor surface are not able to fall past the panel 42. Moreover, the transparent nature of the panels 42 enables operating personnel to be able to see, such as from beneath, if anything as fallen past the conveyor surface and is disposed at, on and/or above the panel 42. It should be appreciated that “transparent” as referred to herein does not require the panel 42 to be clear or see through to the extent of a glass windowpane. Rather, the transparency of the panels 42 allows for and is understood to encompass translucent panels in which an object that falls past the conveyor surface may be observed but is not necessarily clearly seen—i.e. its presence is visually detectable. The transparency of the panels 42 may further enable operating personnel to be able to see, such as from beneath, the location of conveyor equipment and components disposed beneath the conveyor surface.

It should further be appreciated, however, that numerous alternative configurations and constructions of underguard panels may be employed within the scope of the present disclosure. This may include, for example, underguard panels in which the top and/or bottom walls are not solid walls but instead may include perforations or openings, as well as various other constructions and configurations. Still further, a corrugated underguard panel within the scope of the present disclosure may be configured with alternative corrugated core configurations with one or more internal walls that are alternatively configured relative to transverse and middle walls 68, 70 discussed above.

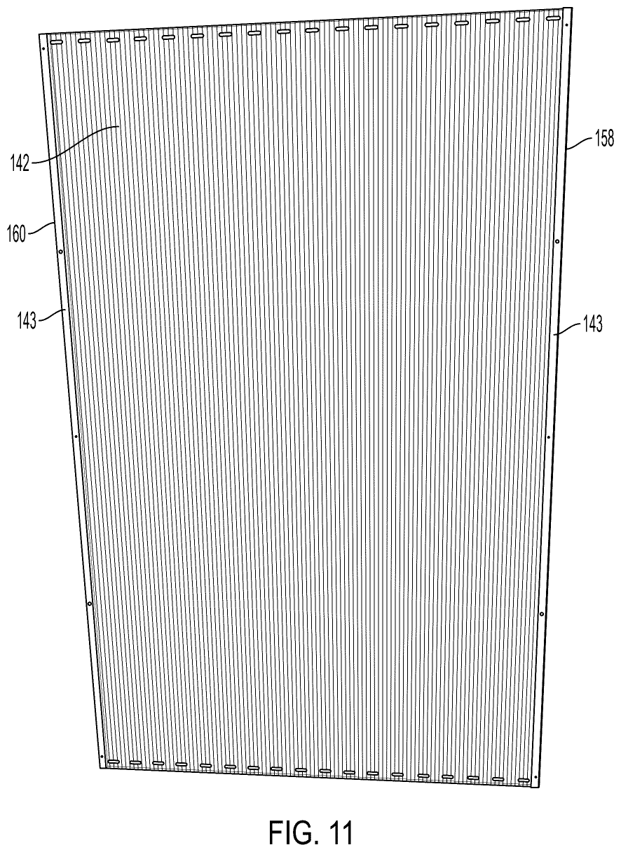

FIG. 11 discloses an alternative undergaurd panel 142 that is substantially similar to the undergaurd panel 42 discussed above, but includes end braces 143 at each transverse edge 158, 160. Each brace 143 comprises a metal C-shaped channel within which the respective transverse edge 158, 160 is inserted with the brace 143 then being secured via fasteners, such as screws. The braces 143 may aid in providing additional rigidity to the panel 142 when mounted to the conveyor assembly 32.

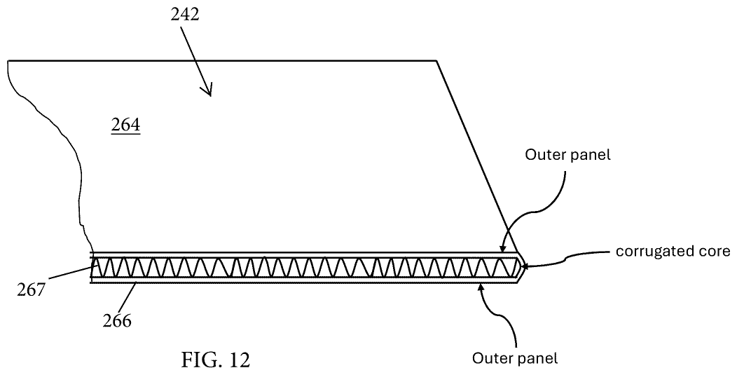

FIG. 12 discloses an alternative underguard panel 242 having top and bottom walls 264, 266 between which an alternative core comprising an inner wall 267 that is generally angled or wave shaped is disposed, wherein the inner wall 267 may define a sinusoidal or triangular shape at the opposite lateral edges of the panel.

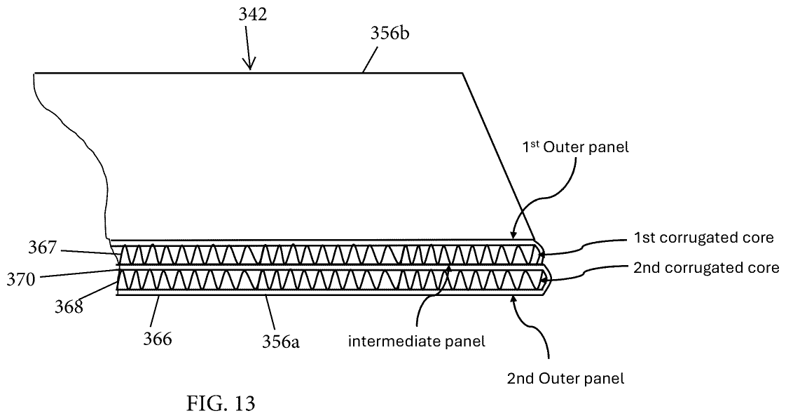

FIG. 13 discloses an alternative underguard panel 342 having top and bottom walls 364, 366 as well as a middle wall 370, with an alternative core comprising a first inner wall 367 disposed between the top and middle walls 364, 370 and a second inner wall 369 disposed between the middle and bottom walls 370, 366, with each of the first and second inner walls 367, 369 being generally wave or angled shaped. Panel 342 may be formed by securing two separate panels, such as panels 242, together wherein the middle wall is formed by a top wall of one panel and a bottom wall of the other panel.

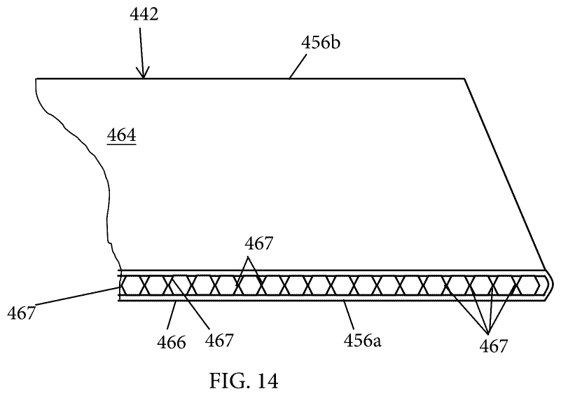

FIG. 14 discloses an alternative underguard panel 442 having top and bottom walls 464, 466 between which an alternative core comprising multiple hexagonal or honeycombed shaped inner walls 467 are disposed.

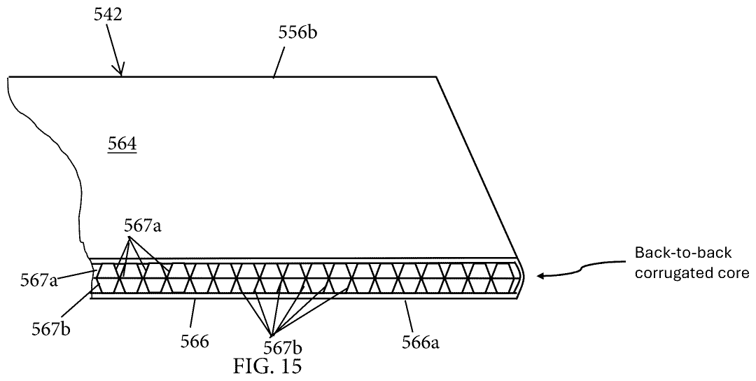

FIG. 15 discloses an alternative underguard panel 542 having top and bottom walls 564, 566 between which an alternative core comprising multiple separate half hexagonal or honeycombed shaped inner walls 567a, 567b are disposed, where the inner walls 567a, 567b are buttressed together, back-to-back, to form the hexagonal or honeycomb core structure.

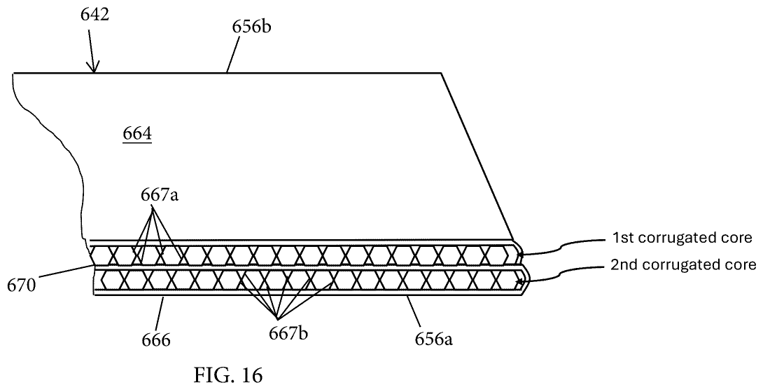

FIG. 16 discloses an alternative underguard panel 642 having top and bottom walls 664, 666 as well as a middle wall 670, with an alternative core comprising multiple hexagonal or honeycombed shaped upper inner walls 667a disposed between the top and middle walls 664, 670 and multiple hexagonal or honeycombed shaped lower inner walls 667b disposed between the middle and bottom walls 670, 666. Panel 642 may be formed by securing two separate panels together wherein the middle wall is formed by a top wall of one panel and a bottom wall of the other panel.

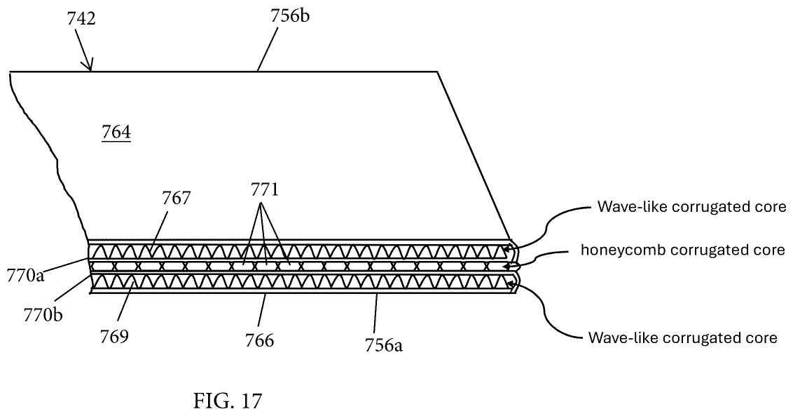

FIG. 17 discloses an alternative underguard panel 742 having top and bottom walls 764, 766 as well as a pair of middle walls 770a, 770b, with an alternative core comprising a first inner wall 767 disposed between the top wall 764 and one of the middle walls 770a, and a second inner wall 769 disposed between the other middle wall 770b and the bottom wall 766, with each of the first and second inner walls 767, 769 being generally wave or sinusoidal shaped. Still further, multiple additional hexagonal or honeycombed shaped inner walls 771 are disposed between the middle walls 770a, 770b. Panel 742 may be formed by securing multiple separate panels together.

As noted the underguard panels are constructed from a non-metallic transparent corrugated polymeric material, which in the illustrated embodiment are disclosed as a plastic material, such as a recycled corrugated polymeric material, or pollution-free polymeric material. This includes polycarbonate plastic, polyvinyl chloride (PVC), acrylic sheets, fiberglass, glass fiber reinforced plastic recycling resins/powder, or any other suitable rigid material that is able to be supported without detrimental deflection. The underguard panels are readily modifiable, such as by way of being cut with various types of handheld saws and blades, including for configuring edges of the panels for installing or mounting around objects such as floor supports, conveyor drives, or other installation requirements.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A conveyor guard that is adapted for use with a conveyor having a pair of spaced apart side channels, each having a lower flange and a plurality of openings on each flange, said conveyor guard comprising:
a conveyor guard panel, wherein the conveyor guard panel comprises;
a non-metallic top wall;
a non-metallic bottom wall;
at least one inner wall disposed between said top wall and said bottom wall; and
a pair of lateral edges; and
wherein said conveyor guard panel is sized such that said lateral edges align with respective ones of the lower flanges of the pair of spaced apart side channels of the conveyor when mounted thereto, and wherein the top wall, the bottom wall and the at least one inner wall each allow light to pass through so as to be transparent or translucent.

2. The conveyor guard of claim 1, wherein the at least one inner wall extends between each said lateral edge.

3. The conveyor guard of claim 1, wherein the at least one inner wall comprises a plurality of transverse walls.

4. The conveyor guard of claim 3, wherein said plurality of transverse walls are disposed perpendicularly to the top wall and the bottom wall, and to the lateral edges.

5. The conveyor guard of claim 4, wherein the at least one inner wall further comprises at least one middle wall, wherein the at least one middle wall is disposed parallel to the top wall and the bottom wall.

6. The conveyor guard of claim 5, wherein each at least one middle wall is disposed between a pair of transverse walls.

7. The conveyor guard of claim 1, wherein the top wall, the bottom wall and the at least one inner wall are unitarily formed.

8. The conveyor guard of claim 1, wherein the at least one inner wall comprises a wave shaped wall, wherein opposite ends of the wave shaped wall are disposed at said lateral edges with each said opposite end defining either a sinusoidal shape or a triangular shape, and wherein the wave shaped wall is joined with each of the top wall and the bottom wall.

9. The conveyor guard of claim 1, wherein the at least one inner wall comprises a middle wall and a pair of wave shaped walls, wherein said middle wall extends parallel to both said top wall and said bottom wall and wherein one of said wave shaped walls is disposed between said top wall and said middle wall and the other of said wave shaped walls is disposed between said middle wall and said bottom wall.

10. The conveyor guard of claim 1, wherein the at least one inner wall comprises a plurality of transverse walls forming hexagonal walls.

11. The conveyor guard of claim 1, wherein the conveyor guard panel further comprises mounting holes adjacent each said lateral edge, wherein at least one mounting hole at each said lateral edge aligns with at least one opening on each flange of the spaced apart side channels of the conveyor, and wherein said conveyor guard further comprises a plurality of connectors for mounting said conveyor guard panel to the flanges via said mounting holes.

12. The conveyor guard of claim 11, wherein said connectors each comprise a threaded fastener having a head, a nut and a spacer extending longitudinally on the threaded fastener forming a gap between the nut and the head, and wherein said conveyor guard panel is disposed at the spacer.

13. The conveyor guard of claim 11, wherein said connectors each comprise a retainer pin and a retainer nut, and wherein the retainer nut includes an internal cavity into which the retainer pin extends with the conveyor guard panel disposed between the retainer nut and a bottom portion of the retainer pin.

14. The conveyor guard of claim 13, wherein the retainer pin comprises a post with a projection and wherein the projection engages with the retainer nut for securing the retainer nut and retainer pin together.

15. The conveyor guard of claim 13, wherein the conveyor guard panel further comprises a magnetic sleeve disposed at selected ones of said mounting holes, and wherein at least one of said retainer pin and said retainer nut are metallic.

16. The conveyor guard of claim 1, wherein at least one of said top wall, said bottom wall and said at least one inner wall are polymeric, plastic, and/or are constructed of at least one of polycarbonate plastic, polyvinyl chloride (PVC), acrylic sheets or fiberglass.

17. A conveyor system comprising:
a pair of spaced apart side channels, each having a lower flange and a plurality of openings on each flange;
a plurality of conveyor rollers extending between said side channels; and
at least one conveyor guard panel mounted beneath said side channels at said lower flanges;
wherein said at least one conveyor guard panel comprises a non-metallic top wall, a non-metallic bottom wall, at least one inner wall disposed between said top wall and said bottom wall, and a pair of lateral edges, and wherein said conveyor guard panel is sized such that said lateral edges align with respective ones of the lower flanges of the pair of spaced apart side channels of the conveyor when mounted thereto, and wherein the top wall, the bottom wall and the at least one inner wall each allow light to pass through so as to be transparent or translucent.

18. The conveyor system of claim 17, wherein the at least one inner wall extends between each said lateral edge.

19. The conveyor system of claim 17, wherein the conveyor guard panel further comprises mounting holes adjacent each said lateral edge, wherein at least one mounting hole at each said lateral edge aligns with at least one opening on each flange of the spaced apart side channels of the conveyor, and wherein said conveyor guard further comprises a plurality of connectors for mounting said conveyor guard panel to the flanges via said mounting holes.

20. The conveyor system of claim 19, wherein said connectors each comprise a retainer pin and a retainer nut, and wherein the retainer nut includes an internal cavity into which the retainer pin extends with the conveyor guard panel disposed between the retainer nut and a bottom portion of the retainer pin.

21. The conveyor system of claim 17, wherein said at least one conveyor guard panel comprises a plurality of conveyor guard panels, and wherein each conveyor guard panel comprises transverse edges, and wherein said conveyor guard panels are mounted to said side channels with a said transverse edge of each said conveyor guard panel adjacent to a said transverse edge of another said conveyor guard panel.
